(19) United States
(12) Patent Application Publication
(10) Pub. No.: US 2009/0130377 A1
(43) Pub. Date: May 21, 2009

(54) Natural Fibre Thermoset Composite Product and Method For Manufacturing the Same

(75) Inventors: Dasarathi Samanta, West Bengal (IN); Anukul Samanta, West Bengal (IN); Mahadeb Samanta, West Bengal (IN); Basudev Samanta, West Bengal (IN)

Correspondence Address: MERCHANT & GOULD PC, P.O. BOX 2903, MINNEAPOLIS, MN, 55402-0903, US

(73) Assignee: A B COMPOSITES PRIVATE LIMITED, STATE OF WEST BENGAL (IN)

(21) Appl. No.: 12/063,911

(22) PCT Filed: Aug. 10, 2006
(86) PCT No.: PCT/IN2006/000287

§ 371 Date: Feb. 15, 2008

(30) Foreign Application Priority Data
Aug. 16, 2005 (IN) 747/KOL/2005

(51) Int. Cl. B32B 5/02

(52) U.S. Cl. 428/113; 156/250

(57) ABSTRACT

A natural fibre thermoset composite product of high tensile strength, high compressive strength, high cross breaking point, high water absorption properties and a method for producing the same. The product comprises bamboo and jute fibre, resins, fillers and additives wherein bamboo and jute are present in the ratio of 1:99 to 99:1 as reinforcement material. The method of manufacture of natural fibre thermoset composite product of high tensile strength, high compressive strength, high cross breaking point, high water absorption properties comprises forming slurry with resin solution, fillers and optional additives; impregnation of bamboo and jute provided in a ratio of 1:99 to 99:1 as reinforcement material into the slurry; drying said impregnated bamboo and jute composite in oven at temperature of 100° C. to 200° C.; cutting said impregnated and dried bamboo and jute composite into required size; said impregnated dried cut pieces of bamboo and jute composite multilayered according to require thickness and pressed in the hydraulic press at a pressure 1 to 3 tons per square inches for a definite period at a defined temperature. The composite product is adapted to be used as floor board, paneling sheet, roofing material and the like.

### FIELD OF INVENTION

The present invention relates to natural fibre thermoset composite products and a method for producing the same. More particularly the invention relates to natural fibre thermoset composite products made mainly from bamboo and jute. The products are adapted to be used as floor board, paneling sheet, roofing material and the like.

### BACKGROUND AND PRIOR ART

Bamboo is one of the fastest renewable plant with a maturity cycle of 3-4 years, thus making it a highly attractive natural resource compared to forest hardwoods. Bamboo offers good potential for processing it into composites as a wood substitute. Bamboo laminates could replace timber in many applications such as furniture, doors & windows and their frames, partitions, wardrobes, cabinets, flooring etc. Accordingly bamboo laminates are being developed from slivers milled out from the bamboo culm. After primary processing comprising cross cutting, splitting and 2-side planing, the slivers are treated for starch removal and prevention of termite/borer attack. The slivers are then subjected to hot air drying followed by 4-side planing for attaining uniform thickness. These slivers are coated with glue on the surface and are arranged systematically. They are subjected to a curing in a hot press (6′×4′ 2-day light) at temp.f ˜70° C. using steam & pressure ˜17 Kg/cm². The pressed laminate (panels/tiles) is then put through trimming, sanding & grooving machines to give a pre-finish shape.

It is also known that mats are woven from bamboo slivers. From split bamboo epidermal layer is removed and slivers of thickness ranging from 0.6 mm to 1.0 mm are made and dried in air to moisture content of around 15%. The dried slivers are manually/machine woven into mats of different sizes and patterns. Herring bone weaving pattern is most common throughout the world.

Bamboo mats are dipped in modified phenol formaldehyde resin mixed with a preservative to increase resistance to termite and decay. Resin coated mats are dried to a moisture content of around 10% either in drying chambers or industrial dryers. Dried resin coated mats are assembled in 2, 3 or 5 plies and hot pressed to produce bamboo mat boards of desired thickness. For thickness greater than 6 mm, bamboo mats are interleaved with wood veneers to make bamboo mat veneer composites.

Investigations were carried out at IPIRTI under a Project sponsored by Building Material Technology Promotion Council to develop an Eco-friendly roofing sheet. Since corrugated sheets are more ideal for roofing application, attempts were made to develop Corrugated Bamboo Mat Sheet (BMCS). For this purpose platens having approximated sinusoidal wave patterns were designed to be fitted with hydraulic hot press to produce corrugated sheets by using bamboo mat coated with suitable resin binder. Extensive experiments were carried out using woven bamboo mats of Melaconna bambusoides & Ochlandra travancorica that were dipped in phenol formaldehyde resin and pressed under temperature and pressure. Sheets made in the initial experiments were subjected to rigorous test for evaluating bond integrity. BMCS thus produced were subjected to performance tests like load bearing capacity, water permeability test, resistance to boiling water and weather ability and found to process excellent load bearing capacity.

BMCS roofing sheets confirms to the requirements prescribed for asbestos cement roofing sheets with enhanced characteristics like toughness, resilience and ductility. Apart from this BMCS is environment friendly, energy efficient and possesses good fire resistance. The BMCS developed is first of its kind in the country.

Laboratory/pilot scale technology for manufacturing Bamboo Mat Corrugated Sheets (BMCS) has been successfully developed under a project sponsored by BUILDING MATERIAL TECHNOLOGY PROMOTION COUNCIL (1995-1999).

Refinement of the technology for commercialization is in progress under a project entitled “Field Demonstration and Development of Bamboo based Composites/panels for housing in North Eastern Region” sponsored by Ministry of Environment and Forests, Government of India. Patent No: 653/MAS/2001 dated Aug. 8, 2001 has been filed for the same

Laminated bamboo sheets, panels, boards, and other forms of construction material for structural and decorative parts of houses, boats and furniture have been developed by Forest Products Research and Development Institute, Philippines and were granted Utility Model Patent No. 43 by the Philippine Patent Office. A study was conducted (Leon, A. J. de 1956. Studies of the use of interwoven thin bamboo strips as stress skin covering of aircraft. Philippine J. Sci. 85: 329-340) using bamboo woven mat glued to wood or laminated to another bamboo mat for use as stress skin covering for light aircraft. Its fatigue strength under bending stress was found to be much higher than that of wood, and the bond strength of bamboo to bamboo was comparable to that between bamboo and wood.

Different types of mats and sheets of varying width and thickness can also be made by interweaving strips of cichu culms. For house construction and for drying agricultural crops, mats used should be big and strong and hence wider and thicker strips are needed. Strips used for making sleeping mats and packing sheets should be smaller and thinner. As for weaving fancy articles such as pictorial curtains and screens, ladyfans, vase or cup slipcovers, etc., only the outer part of cichu culms is selected and then split into wire like strips of amazing uniformity and fineness. During World War II, the Chinese Bureau of Aeronautical Research studied bamboo mat boards and made bamboo mat oil tanks. They split cichu culms into thin strips, interwove them into bamboo mats, glued three four layers of mats together and pressed them into boards which finally were moulded into oil tanks of appropriate size. Today, the technology used for the manufacture of bamboo mat boards is highly developed. Numerous varieties of bamboo mat boards are produced from culms of S. affinis and other bamboos in Sichuan and are used for the purpose of decoration or making furniture, walls, ceilings, floors, and also for packaging and other constructional purposes. (Proceedings of the International Bamboo Workshop held in Cochin, India from 14-18 Nov. 1988, Editors, I. V. Ramanuja Rao, R. Gnanaharan, Cherla B. Sastry).

China has developed the maximum number of panel products, although many of these are based on commercially uncertain technologies. Although some pioneering work was done and innovative products like plybamboo (bamboo veneer-faced plywood) and Bamboo (parallel curved bamboo gluelam) were developed in Taiwan-China, the bamboo board industry in this region is declining since the sharp increase in wages and raw material shortage are causing the manufacturers to emigrate elsewhere.

In India, although several products have been developed, bamboo mat board is the only one that has attracted entrepreneurs and gained user acceptance. In Thailand, bamboo mat board glued with urea-formaldehyde (UF) resin is being manufactured, mainly for export. In countries such as Laos, the Philippines and Vietnam, interest on bamboo board is recent and still experimental or at the level of pilot production.

As bamboo panel products have not been accorded uniformly distinctive categorization in compilation of statistics, reliable production data are not available. Absence of reliable production and market statistics is a severe handicap in evaluating the current status and future prospects of bamboo boards. Projections have, however, pointed out the important role of bamboo boards in view of diminishing wood supplies.

Boards from Slivers, Strips or Laths

Slivers of uniform thickness and width are woven into mats, following traditional or innovative designs and cold or hot pressed into boards to produce:

Bamboo mat board Vietnam—In China, India, the Philippines and
Corrugated sheet—Surface finished or laminated in China, India, the Philippines and Vietnam for use in roofing.
Strips/slivers assembled in layers and bonded under pressure to produce:
Parallel gluelam—To a limited extent in China.
Parallel curved gluelam (Bamboo)—In Taiwan-China region for furniture.
Bamboo curtain board—In China.
Bamboo strip board/bamboo plywood—In China, and also to a small extent in Costa Rica, Malaysia, Taiwan-China and Vietnam.
Bamboo lath board/bamboo block board—In Indonesia on an experimental scale.
Bamboo “semi-fiber” board—A product simulating “zephyr” wood, in which culms are crushed under pressure and assembled in layers and hot-pressed (experimental scale in Indonesia).
Bamboo net board—In limited quantity in China.
Bamboo moulded shuttle & picking stick—In restricted quantity in China.
Boards from Veneer
Plybamboo—A highly decorative product, in which rotary-cut bamboo veneers are used as face and wood veneers or blocks as core, is produced at present in small quantities in China.
Boards from Reconstituted Particles, Strands or Fibers
Bamboo particleboard—Largely following technology employed for wood particleboard, bamboo particleboard has been developed in Canada (in collaboration with Costa Rica), China, India and Vietnam. Although the product is comparable to wood particleboard in properties and performance, production is limited as the technology is yet to overcome some inherent problems of bamboo.
Oriented strand board—Research is reported in Vietnam.
Bamboo fiberboard and medium density fiberboard (MDF)—Research in progress in China and India. A small quantity is produced in China.

### Composite Boards

Bamboo mat/bamboo curtain board—Developed in China.
Bamboo mat/bamboo particleboard and India—Produced in small quantities in China
Bamboo plywood—Bamboo mats are used as face and wood veneers as core. A popular product in China and India.
Bamboo curtain plywood—Bamboo curtain board is used as face and wood veneers as core. Small quantity produced in China.
Bamboo mat and wood particleboard—Bamboo mat is used as face and wood particleboard as core. Produced in limited quantity in China.
Bamboo mat and rice husk board—Bamboo mat is used as face and rice husk particleboard as core. Produced in small quantity in India.
Bamboo strip, wood veneer and particleboard—Bamboo strip board forms the face. Wood veneer and particleboard are used as core.
Bamboo moulded shuttle beating club—A tough product, in which bamboo sliver and wood veneer are bonded. Made in very small quantity in China.
Gypsum-bonded bamboo particleboard—Produced on an experimental scale in the Philippines.
Cement-bonded particleboard and wool board—Produced on an experimental basis in China. The former is produced in Malaysia also.
Bamboo plaster board—An innovative product being developed in China.
Bamboo reinforced plastic—A high-tech material under experimentation in India. Bamboo fiber reinforced plastic sheets are being developed.

Of the above types of boards, only bamboo mat board (a bamboo panel that has shown maximum promise) and bamboo strip board have been exploited on an industrial scale and products marketed for various end-uses. Other technologies are either in various stages of development or only at the initial stages of experimentation. Further research is foreseen in these cases.

Bamboo mat corrugated roofing sheets are produced in China (known as bamboo mat corrugated plywood) and, to a limited extent, in Vietnam. Exploratory studies have recently been initiated in India and the Philippines.

In China four layers of mat bonded with UF resin adhesive are used. The top layer is overlaid with UF resin-impregnated, reprocessed paper. On top of this, PF resin is impregnated by hot-pressing. The production process is as follows:

Drying of mats to 8-12% moisture content;
Application of UF resin;
Overlaying UF resin-impregnated, reprocessed paper;
Pressing between two corrugated cauls in a specially designed press;

### Laying up;

Overlaying PF-resin impregnated film;
Hot-pressing (in a specially designed press); and

### Trimming.

Another process employed is to dry the mats to 12-14% moisture content; apply PF resin adhesive (400 g/m²) and press 5 layer boards between corrugated cauls in a specially designed hot press.

The physical and mechanical properties of corrugated roofing sheets with and without overlays are shown in Table 8.

In Vietnam corrugated roofing sheets are produced to a limited extent. The technology of China is adopted.

Exploratory studies are in progress in India and the Philippines. Efforts in India are to develop corrugated sheets in single pressing cycle employing PF resin.

### Parallel Gluelam

This specialty panel is produced in China as bamboo sliver laminated board. There are two types: single structural panel and non-single structural panel. In the former, all slivers are placed parallel to each other, while in the latter a few are placed crisscross. The technology is as follows:

Conversion of culms into slivers. 15-20 mm wide and 0.8-l 2 mm thick;
Removal of slivers with epidermal layer;
Drying to less than 15% moisture content;
Application of PF resin adhesive (dipping);

### Laying up;

Hot pressing for 1½ to 2 hours (for 30-32 mm thick panels) at a temperature of 110-160° C. and a specific ‘pressure of 4-6 Mpa (increasing gradually in steps); and Trimming.

The main applications for this panel are for truck floors, gang planks and, less commonly, in building construction. While it is a material of great strength, its weight is a disadvantage. Moreover, it requires large quantity of resin, thereby pushing up the cost and pressing time.

### Parallel Curved Gluelam

This specialty panel (locally known as ‘lamboo’) is produced in Taiwan-China and used in furniture making. The aesthetically designed curvature and attractive color imparted by dyeing produce highly valued panels for manufacturing furniture. Moso bamboo (Phyllostachys pubescens) and Ma bamboo (Dendrocalamus latiflorus) of 8 cm diameter at the bottom end and 2.5 cm at the top were found to be the most suited. The technology is as follows:

Conversion of culms into slivers;
Dipping in acidic dye solution at 80° C. temperature and under 10 kg/m² pressure to impart attractive color;
Preservative treatment with sodium pentachlorophenate (NaPCP) or Tenalith C (former is found to be better);

### Drying;

Application of glue a mixture of urea formaldehyde (UF), melamine formaldehyde (MF) and polyvinyl acetate (PVA) in the ratio of 55:12:33 at the rate of 100 l 50 g/m 2 on dry basis, including on the sides of slivers to make wider panels; and
Bending narrower panels into desired shapes, after subjecting to steam treatment.

### Bamboo Curtain Board

This is a relatively new panel produced in China and Taiwan-China. Culms are cut into thin slivers and formed into “curtains”, with slivers placed side by side and parallel to each other. The board is assembled by placing layers of curtains with slivers of one layer at right angles to the other, followed by glue application and pressing. The panel, thus, resembles plywood in construction.

The three-layered boards generally manufactured are locally known as bamboo curtain plywood. It is found that several species of bamboo are suitable for this, and the process of making curtains is simpler and less time-consuming than weaving mats. In view of the simple processing technology and high quality of the product, this panel has high potential. The technology is outlined below:

Large thick strips of flattened culms are converted into slivers of uniform width (between 10 and 20 mm) and thickness 1 mm (conversion manually or mechanically);
Drying to 10-12% moisture content;
Weaving slivers into curtains;
Adhesive application (generally by dipping in PF glue);
Hot-pressing for 22½ minute/mm thickness at a temperature of 140 l 50° C. and a specific pressure of 34 MPa; and
Trimming to 4 500×1 300 mm size (6, 12, 16, 20 or 30 mm thickness) and end-sealing.

Paper-laminated bamboo curtain plywood is produced more commonly. The paper normally used is resin-impregnated Kraft paper. PF (at 80-120 g/m²) or modified melamine is used as resin adhesive. Impregnation of resin is accomplished by dipping. Before dipping, small amounts of a diluent and release agent are added to the resin. After resin impregnation, the paper is dried. One or two layers of dried paper are placed on either faces of a layer of bamboo curtain board, and hot-pressed into shape by preheating (50-135° C.), curing and shaping (1½ to 2 minutes/mm thickness), and cooling to 50° C.

Laminated bamboo curtain plywood is used in concrete formwork, and has gained wide acceptance as compared with steel and plywood formworks, because it is: lighter; cheaper; easier and quicker to assemble; more heat-resistant; and ideal to get smooth formwork surface. These advantages have earned it official endorsement, and steel frame bamboo curtain plywood has been declared as the ideal formwork material.

### Bamboo Strip Board

A panel of high strength, stiffness and rigidity, the board is also called bamboo strip plywood and bamboo plywood. Resistance to deformation, abrasion and weathering characterizes it. Its bending strength, torsion and impact resistance are superior to wood panel and therefore its application potential particularly as platform boards, vehicle platforms, rail carriages, ship floors, etc. is very high. It is produced in China, and to a small extent in Costa Rica, Malaysia and Vietnam.

In China next to bamboo mat board, this is the most popular bamboo-based panel and is used in vehicle bodies. The technology involves:

Cross cutting of culms to desired strength;
Scraping and removal of nodes (outer surface), and removal of epidermal layer using a specially designed tool;
Softening, steaming at about 160° C. and flattening;
Scraping of nodes (inner surface);
Drying to 8% moisture content;
Planing edges and surfaces;
Application of PF resin adhesive at the rate of 350-400 g/m²;

### Assembly;

Hot-pressing for 1 minute/mm thickness at a temperature of 140150° C. and a specific pressure of 3 MPa; and

### Trimming.

The major uses are for:

Concrete formwork (paper-laminated bamboo strip board is used) It is found that reuse is as many as 200 times and superior in one or more respects to formwork of plywood, MDF, steel, plastic, GRP, aluminium, etc.

Platforms for trucks, buses, rail coaches, spring boards Estimated to be in use in over 115 000 carriages, replacing about 52 000 m 3 timber and 1 700 t of steel, and reducing deadweight in each coach by 53 kg.

The Costa Rica Building Research Center (CIVCO), with the cooperation of the Queen's University of Canada, has developed a bamboo strip board called ‘plybambu’. It is still in the experimental stage and a small quantity is produced on a laboratory scale. Guadua spp. is employed and PVA is used as binder. This product is expected to find interior applications like doors, windows, partitions, ceilings, etc. Further work is in progress to achieve consistent physical and mechanical properties.

In Malaysia a small quantity is produced using manually split culms bonded with PVA. Prior to drying and application of adhesive, the strips are dipped in 2% solution of borax and 2% solution of NaPCP for protection against insects and fungi. Typical applications are as parquet, flooring boards, built-in wardrobes, cabinets, etc. Physical and mechanical properties of these boards are given in Table 12.

In Taiwan-China more or less the same manufacturing process followed in China is used here. The product, because of its high strength and durability, finds wide-ranging applications, especially in truck bodies and railway carriages.

In Vietnam Bamboo strip board is a recent development in the country and is gaining popularity. The technology involves:
Crosscutting of culms;
Splitting;
Scraping of nodes on both outer and inner surfaces;
Preservative treatment (dipping in mixture of NaPCP and sodium fluoride)
Drying to 8-12% moisture content:
Application of resin (melamine urea formaldehyde at the rate of 140-160 g/m²);
Hot-pressing for 9 minutes (for 16 mm thick panel) at a temperature of 120 l 40° C. and a normal pressure of 1.2-1.6 MPa; and
Finishing by paint or varnish.

The board is used in interior applications like ceiling, parquet flooring, etc.

Although the board is strong and application potential is wide, its manufacture has not expanded on account of problems such as high energy requirement for flattening, suitability of only species with thick-walled culms, and requirement of sophisticated machinery.

### Bamboo Lath Board

In China this innovative panel is produced in a limited quantity, under the name ‘bamboo laminated lumber’. Long strips are used in boards of sizes 4 070×140×30 mm and 5 370×140×30 mm. The procedure is as follows:

Cutting of culms into long strips 2 200/2 850 mm in length, 11-15 mm in width and 1-2 mm in thickness;
Drying to 8-10% moisture content;
Dipping in PF resin adhesive in specially made tanks;
Assembly in layers with laths oriented in the same direction or at right angles and
Hot-pressing for about 60 minutes at a temperature of 130140° C.

This relatively new product developed in Indonesia is sometimes referred to as ‘bamboo blackboard’. It is similar to strip board except that the strips are much larger in size. Although the technology is still undergoing refinement, a small quantity has been produced and strength values—particularly MOE and MOR—have been found to exceed those of wood-based panels. The technology, is as follows:

Conversion of culms into laths of uniform width and thickness;
Drying to 10-16% moisture content;
Adhesive (PVA) application;
Assembly in layers (laths of each layer at right angles to the other);

### Hot-pressing; and

### Trimming.

The potential of the product as an alternative building material is very high, and it is presently being tried for flooring, tiles and partitions.

Laminated lumber has excellent water resistance, durability, dimensional stability and strength properties, and is used in building construction and carriage platforms. However, its production is limited at present.

### Bamboo “Zephyr” Board

This bamboo counterpart of “zephyr” wood has been developed in Indonesia and is locally called ‘semi-fiber bamboo board’. It is also a variant of strip board, but here the culm is crushed into strands of fiber. A small quantity of this board has been produced and the technology is undergoing further trials. The process is as follows:

Splitting of fresh culms;
Crushing of split culms under pressure;
Drying to 10-12% moisture content;
Soaking in resin (both UF and PF resin have been employed);
assembly (culm fibers of one layer at right angles to fibers in the other layer);

### Hot-pressing (at 120° C. for UF and 160% for PF); and

### Trimming.

The product tested according to the Japanese Standard JIS A5908 has shown that it is not inferior to zephyr wood.

### Bamboo Net Board

This product, analogous to honeycomb plywood, has recently been developed in China and a small quantity produced. In this panel called ‘bamboo net board’, thin, narrow slivers of varied sizes are used as core and bamboo strips or resin-impregnated paper as face and back layers. Various decorative designs have been developed for the face and back. The board has a density of 338 kg/m³, an MOR of 10-15 MPa and a compressive strength of 5.5 Mpa. At present, it is being tried out in furniture and packaging, and also as insulation board in housing. (Bamboo Panel Boards a State of the Art Review, International Network for Bamboo and Rattan)

In the Indian patent number 179504 the natural fibre thermoset composite fire retardant sheet/board and components mainly from Jute of any form or of any fibre or mixture is taught. The dried Jute of any form or of any fibre or mixture when impregnated in the slurry made from phenolic resin dissolved in methanol along with filler and hardener, which is further dried out into required size and made multilayered as per the required size and thickness and pressing by hydraulic press at a pressure 1-3 ton per square inches for a period of 5-30 minutes at a temperature of 100-200° C. and finally trimming the multilayered pressed material/components in required size to form moulded Natural Fibre Thermoset Composite Sheet/Board and Components. It is observed that the Board/Sheet and Components Products by this process are for the better quality of various Industrial applications.

U.S. Pat. No. 5,876,649 teaches shaped load-carrying structures fabricated using bamboo linear fibers with a compatible bonding material and synthetic polymers such as polyesters, epoxies, and polyolefins. The structures are manufactured by coating at least one of bamboo culms, split bamboo culms, bamboo fiber tape, or prepared bamboo fibers with a bonding material to produce a core. The core is then combined with a polymer matrix and extruded or molded to form a structure having the desired shape. The structures compare favorably with wood, steel, and concrete regarding strength, longevity, price and ability to withstand earthquakes. The structures may be used as beams, columns, telephone poles, and marine piles.

In this art it has been found that the following binding agents give surprisingly good bonding between the bamboo and the polymer matrix. maleated polypropylene, maleated polyethylene, maleic anhydride, hydroxyl methacrylate, silane compounds, N-vinyl pyridine, N-vinyl caprolactam, N-vinyl carbazole, methacrylic acid, ethyl methacrylate, isobutyl methacrylate, sodium styrene sulfonate, bis-vinyl phosphate, divinyl ether-ethylene glycol, vinyl acetate, vinyl toluene, vinylidene chloride, chloroprene, isoprene, dimethylaminoethyl methacrylate, isocetylvinyl ether, acrylonitrile, glycidyl methacrylate, N-vinyl pyrrolidone, acrylic acid, ethyl acrylate, itaconic acid, methyl acrylate, sodium vinyl sulfonate, cetyl vinyl ether, divinyl ether-butanediol, and octadecyl vinyl acetate.

For formation of the said load carrying structures plastics extruding line is connected to a die that allows the bamboo fibers primed with at least one of the above binders to fill the outside circumference of a die. The mixture of primed bamboo fibers, plastic is extruded as a column and enters powered pullers that are capable of extracting the column to form any practical length. The thus-prepared composite structure is transferred to a water-cooled bath where it is cooled to ambient temperatures and the sawed ends are capped.

In an alternate method of preparing bamboo fiber/plastic composite structures the bamboo fibers are primed by coating at least one of the above binders by immersing the bamboo fiber in a bath of the primer, spraying the binder onto the bamboo fiber, or brushing the primer onto the bamboo fiber. The primed bamboo fiber is secured to a carrying core of wood or metal to form a core assembly and this core assembly is inserted into a mold and positioned so as to allow clearance for the plastic matrix to flow around all exposed surfaces in desired thicknesses.

Some plastics have an almost unlimited life span when exposed to the elements. This explains the ability of fiberglass to dominate the marine market where wood and steel require too much maintenance. However, plastics by themselves lack sufficient tension and compression strength to stand alone as load-carrying structures. The marine industry solved this problem with the addition of glass fibers to the plastic matrix resulting in fiberglass. This engineered composite has three times the load-carrying capability of steel of an equal weight. The cost of glass fiber reinforced plastics has limited this material to special products and niche markets. Asian and some South American bamboo species such as Gradua and Tonkin cane have tension strength close to steel and compressional strength exceeding concrete. At 1/100 the cost of glass fiber, linear bamboo fiber can be more competitive with traditional materials. By utilizing fiber in a plastic matrix the resulting composite is very strong and has the nearly unlimited life span of the plastic exterior.

In order to produce beams and columns from the composite, the bamboo linear fiber must bond to the plastic matrix. The elongation of the plastic glue allows the load to be evenly distributed along all of the unidirectional bamboo fibers. This is the key to the exceptional strength of the composite structures. A bonding material of at least one of the materials named above, preferably acrylic acid, is used, allowing difficult matrices, such as polyethylene, to bond to the bamboo fibers 6. In making the structures, a bamboo culm is split to its desired size. The fibers 6 may take the form of a full width split bamboo culm, smaller slices, or a tape. The linear bamboo fiber is treated with at least one bonding agent as described above, most preferably acrylic acid or maleic anhydride or salt or ester derivatives thereof, to promote the adhesion of the fibers to the synthetic polymer matrix. The synthetic polymer may be a thermosetting resin or a thermoplastic resin.

The molted plastic is used to completely envelope the bamboo fiber and the mixture of bamboo fiber and synthetic polymer is formed of desired length for the structures.

For making columns having maximum compressional load-carrying capacity, the bamboo culms are not split, but are left in their original hollow shape. These bamboo culms are treated with at least one of the bonding materials named above and are inserted into a mold. The synthetic polymer is then introduced into the mold to bond to, and surround, the bamboo culms. In this way, support columns of exceptional load-carrying ability and the ability to withstand seismic events and other horizontal pressures are produced.

US application no 20050048273 relates to the field of composite materials, and more particularly to load bearing and other structural materials with bamboo and other non-wood cellulosic cores, and methods to make such cores and composites. More particularly it teaches a method and apparatus for pultrusion of a plastic member having a bamboo-reinforced core. The apparatus includes an input and series of die assemblies for taking bamboo tape and embedding it in an appropriately shaped composite member. A pultrusion and saw assembly maintain production at an efficient and desired rate for the particular shape(s) and type of end product being produced. Alternative embodiments are also shown for the processing of bamboo into tape and ribbon forms usable by a pultrusion machine.

The Indian patent 179504 teaches a method of manufacture of jute composite products. The said method comprise formation of resin solution, addition of filler and additives to form slurry, impregnation of jute cloth in the slurry, drying the impregnated jute cloth and pressing it to multilayered product according to need. However the composite product formed from this composite have cross breaking strength, compressive strength and the tensile strength which are low. Accordingly the product from jute composite is not suited to with stand certain conditions like seismic variations.

The US patent documents though teach formation of composite with bamboo and apparatus for the same so that the product has high tensile strength and capacity to withstand seismic variations, they include use of plastic/synthetic materials. These are therefore not biodegradable. These are basically the Thermoplastic material having the tendency to melt in a temperature about 70° C. and accordingly, it will delaminate at a temperature of 50° C. to 70° C. Moreover, it cannot withstand below 0° C. while the present inventors have now found that products from bamboo-jute composites by using particular resin form the thermoset material which can withstand from 200° C. to −30° C. as well as capable of withstanding seismic variations.

Thus there are various forms of boards and panels developed from bamboo alone, in combination with paper, bamboo mixed with specific resins and compressed and laminated in to various products suitable for use in building purposes. However such bamboo boards, panel corrugated sheets have disadvantages of their own. Such bamboo products have the physical property of Water absorption, which is more than 10%. Also they have lower tensile strength, lower cross breaking point. These are formed from bamboo and not a composite of bamboo with other natural fibre. Moreover, it is prone to fire with every possibility of termite attack and U.V. non-resistant.

Accordingly there is need to produce a composite which is biodegradable and would have high tensile strength, high compressive strength, high cross breaking point, low water absorption properties and at the same time be light, eco friendly, easy to assemble, cost effective and capable of withstanding seismic as well as other weather variations.

### OBJECTS OF INVENTION

Thus the main object of the present invention is to provide natural fibre thermoset composites product having high tensile strength high compressive strength, high cross breaking point, Low water absorption properties comprising bamboo and jute and adapted to form board, paneling sheet components.

Another object of the present invention is to provide a method to produce natural fibre reinforced thermoset composite product comprising bamboo and jute of any form or of any fibre or mixture and adapted to form board, paneling sheet components

A further object is to provide the natural fibre thermoset composite wherein binder is selected from Phenolic, U.F. and/or MF resin, modified there of unsaturated polyester resin and a combination of any of those in different ratio.

It is another object of the invention to produce a product i.e. fibre board or sheet made of said composite comprising natural fibre of bamboo and jute of any form or mixture which replace costly eco-Enemy and Non-Biodegradable fibre glass sheet/board.

### SUMMARY OF INVENTION

Thus according to one aspect of the present invention there is provided natural fibre thermoset composite product of high tensile strength, high compressive strength, high cross breaking point, low water absorption properties comprising bamboo and jute fibre, with or without other natural fibres selected from Bulrush (Hogla), Hem, Sisal, Banana and pine apple, coconut fiber (coir), wheat flour, walnut shell flour, cashew nut shell flour, rice husk, sugar cane bagasee, wheat straw, rice straw, jute stick powder, wheat bran, resins, fillers and additives wherein the bamboo and jute are present in the ratio of 1:99 to 99:1 and said natural fibres in amount of 1%-90% by wt., when present, of the fillers, additives and reinforcement material.

According to another aspect a method of manufacturing natural fibre thermoset composite product of high tensile strength comprising:
i) forming slurry with resin solution, fillers and additives;
ii) impregnation, coating or spraying (other processing methods like coating, spraying, or a dry method, like spraying resin solution, coating or no solvent method,) of bamboo and jute with or without other natural fibres selected from Bulrush (Hogla), Hem, Banana and pine apple with the slurry;
iii) drying of said impregnated/coated or sprayed reinforced components (fibers) in oven at temperature of 50° C. to 200° C.;
iv) cutting said impregnated, coated or sprayed reinforced components and dried into required size;
v) said impregnated coated or sprayed or sprayed reinforced components dried cut pieces of bamboo and jute with or without said natural fibres multilayered according to require thickness and pressed in the hydraulic press at a pressure 0.1 to 20 tons per square inches for a definite period at a defined temperature;

### DETAILED DESCRIPTION OF INVENTION

The natural fibre thermoset composite product of high tensile strength, high compressive strength, high cross breaking point, low water absorption properties of present invention is formed mono or multilayered products like floor board/paneling sheet/components. The ratio of bamboo to jute in the said composite product is 1:99 to 99:1 of the reinforcement material.

The natural fibre thermoset composite product of high tensile strength high compressive strength, high cross breaking point, low water absorption properties of present invention has following enhanced physical properties. It is cost effective compared to fibre glass and having more or less similar properties:—

| | |
|---|---|
| Cross Breaking (Mpa) | 100-120 |
| Tensile (Mpa) | 40-100 |
| Density (gm/cc) | 1.0-1.4 |
| Water absorption (%) | 1.0-5.0 |
| Fire Retardant (In Second) | 05-30 |
| Compressive strength (Mpa) | 200-210 |

The natural fibre thermoset composite product of high tensile strength, high compressive strength, high cross breaking point, low water absorption properties of present invention comprises bamboo in 10 to 90% by weight, and/or jute in 5 to 90% by weight. Jute can be used as raw Jute, Jute Felt, Jute Cloth of any form or any other Jute fiber form and Bamboo is in the form of strips, weaving mat, ordinary mat, powder, granules or any other form of reinforcement material.

The filler of 10 to 90% in weight is selected from Aluminium Try-hydrate, Calcium Carbonate, Coconut Shell Dust, Marble, Mica, Talc, Zinc Stearate, Rubber, chlorinated paraffin wax and Fly Ash, carbon blacks, fumed silica, precipitated silica, Alumina, ZnO, TiO2, Calcium Stearate, nanoclays like monmorillonite, bentonite, china clay, borates, phosphate, sulfate salts, Calcium Oxide, Magnesium Oxide, Slate dust, graphite, dolamite, wallastonite, Gypsum, Barytes, wheat flour, walnut shell flour, rice husk, sugar cane bagasee, wheat straw, rice straw, jute stick powder, cashew nut shell flour, Wheat bran, tributyl, Tin Oxide, sodium pentachlorophenate, borax, sodium floride, ammonium hydrogen phosphate and ammonium poly phosphate at 1%:40% and 40%:1% or part of the above fillers and additives.

Resin in 5 to 80% weight is selected from Phenol Formaldehyde (PF), Phenol Urea Formaldehyde (PUF), Urea Formaldehyde (UF), Melamine Formaldehyde (MF), Phenol Melamine Formaldehyde (PMF), Melamine Urea Formaldehyde (MUF) and the modified form of these resins as polymer.

Substituted phenols employed in the formation of the Phenolic resins include, for example, alkyl substituted phenols, aryl substituted phenols, aralkyl substituted phenols, cycloalkyl substituted phenols, alkenyl-substituted phenols, alkoxy substituted phenos, aryloxy substituted phenols, and halogen-substituted phenols, the foregoing substituents possibly containing from 1 to 20 and preferably from 1 to 8 carbon atoms. Specific examples of suitable phenols for preparing the resole resin composition of the present intention include; hydroxybenzene (phenol), o-cresol, m-cresol, p-cresol, 3.5-xylenol, 3.4 xylenol, 3.4.5-trimethylphenol, 3-ethyl phenol, 3.5-diethyl phenol, p-butyl phenol, 3.5-dibutyl phenol, p-amyl phenol, p-cyclohexyl phenol, p-octyl phenol, 3.5 dicyclohexyl phenol p-phenyl phenol, pcrotyl phenol, phenylethyl, 3.5 dimethoxy phenol, 3.4.5-trimethoxy phenol, p-ethoxy phenol, p-butoxy phenol, 3-methyl-4-methoxy phenol, p-phenoxy phenol and mixture thereof. Ordinary phenol normally is preferred for most applications on resin.

Formaldehyde can be used along or in combination with any of the aldehydes or other equivalents heretofore employed in the formation of phyenolic resin including for example, acetaldehyde, propionaldehyde, butylaldehyde furfuraldehyde and benzaldehyde. In general, the aldehydes employed have the formula R′CHO wherein R′ is a hydrogen or hydrocarbon radical generally of 1-8 carbon atoms.

Unsaturated polyester resin and the like by alone or mixture with P.F., M.F., U.F. in proportion of 10% to 90% and 90% to 10% of resin.

The Additives in amount of 0.1 to 30% are selected from Ammonium Phosphate, Zinc Borate, Antimony Tri-Oxide and Borax of filler.

The products from Jute Bamboo Composites of the present invention are as below:—
1. Plain Sheet/Board
2. Chequered Sheet/Board
3. Corrugated Sheet/Board
4. Doors & Windows with Frame
5. Packing Ring
6. Packing for Break-down-Crane
7. Location Box
8. Floor Board for Railways
9. Industrial and Household Products
10. Flooring and Paneling Sheet/Board
11. Prefab Shelter

The panels/sheet formed of the said composite may be used for various purposes:

Railway Coach Components like Packing Ring, Packing for Cranes, Seat-cum-Back Rest besides ceiling, Floor Board, Paneling and Chequered Board etc.
Household Components i.e. Doors, Windows, Furniture of different size and shapes and Corrugated and Plain Sheets.
Defence and Military Items, Prefabricated Shelters of any shape and size including ‘Igloo’ shape etc.
Ship Building Components—Deck covering seating arrangement furniture, ceiling, paneling and flooring etc.

The composites may be formed into products like plain and corrugated sheet to make low cost housing in rural areas and Tsunami effected/Earthquake prone area within a very short period.

For the process of manufacture the resin is dissolved in methanol, water and any suitable solvent. A slurry is made from the resin along with cross linking agents and fillers. The bamboo and the jute in the ratio of 1:99 to 99:1 of reinforcement material is impregnated in the slurry (all other different methods as discussed earlier) and dried. It is further dried out into required size and made multi-layered as per required size and thickness and pressing at a pressure of 0.1-20 tons per square inches for a period of 0.5-60 minutes at a temperature of 70-200° C. and finally trimming the multi-layered pressed material/components in required size to form moulded natural fibre thermoset composite products i.e. floor board/paneling sheet/components with finishing and painting as per the requirement of the customers.

The resin is present in amount of 5 to 80% weight. The resin solution is formed by reacting phenols with formaldehyde in the molar ratio (1.0:0.6 to 2.5) in both acid and alkaline condition.

Substituted phenols employed in the formation of the Phenolic resins include, for example, alkyl substituted phenols, aryl substituted phenols, aralkyl substituted phenols, cycloalkyl substituted phenols, alkenyl-substituted phenols, alkoxy substituted phenos, aryloxy substituted phenols, and halogen-substituted phenols, the foregoing substituents possibly containing from 1 to 26 and preferably from 1 to 9 carbon atoms. Specific examples of suitable phenols for preparing the resole resin composition of the present intention include; hydroxybenzene (phenol), o-cresol, m-cresol, p-cresol, 3.5-xylenol, 3.4 xylenol, 3.4.5-trimethylphenol, 3-ethyl phenol, 3.5-diethyl phenol, p-butyl phenol, 3.5-dibutyl phenol, p-amyl phenol, p-cyclohexyl phenol, p-octyl phenol, 3.5 dicyclohexyl phenol p-phenyl phenol, pcrotyl phenol, phenylethyl, 3.5 dimethoxy phenol, 3.4.5-trimethoxy phenol, p-ethoxy phenol, p-butoxy phenol, 3-methyl-4-methoxy phenol, p-phenoxy phenol and mixture thereof. Ordinary phenol normally is preferred for most applications in preparation of resin.

Formaldehyde can be used along or in combination with any of the aldehydes or other equivalents heretofore employed in the formation of phyenolic resin including for example, acetaldehyde, propionaldehyde, butylaldehyde furfuraldehyde and benzaldehyde. In general, the aldehydes employed have the formula R′CHO wherein R′ is a hydrogen or hydrocarbon radical generally of 1-8 carbon atoms.

The resin solution may also be formed by reacting urea with formaldehyde in the molar ratio (1.0:3.0) in presence of alkaline catalyst or by reacting Melamine with formaldehyde in the molar ratio (1.0:3.0) in presence of alkaline catalyst or as a mixture of PUF, PMF or MUF in required proportion.

In UF, MF, PMF, MUF, PUF formaldehyde can be used alone or in combination with any of the aldehydes or their equivalents heretofore employed in the formation of Phenolic resin including, for example, acetaldehyde, propionaldehyde, butylaldehyde, furfuraldehyde, and benzaldehyde. In general, the aldehydes employed have the formula R′CHO wherein R′ is a hydrogen or hydrocarbon radical generally of 1-8 carbon atoms.

The modified resin Phenolic, Melamine and Urea may also be formed by reacting Phenolic, Melamine and Urea with Formaldehyde modified by any of the material namely, Cresol, Cryslic Acid, Cardanol, Resorcinol, Cashew Nut Shell Liquid (CNSL), Ligno Sulphate Liquer (LSL) and Hydrolised Shellac in presence of Acid/Alkali catalyst in proportion of 1% to 90% by wt. and any of the above material in 100% may react with required proportion of Formaldehyde.

Linear unsaturated polyester is obtained by reacting, in the presence of an inhibitor and of a metal catalyst, together: 5-30 mol % of one or more ethylenically unsaturated decarboxylic acids (A) selected from the group consisting of maleic acid, maleic anhydride and fumaric acid, 20-45 mol % of one or more other aliphatic or aromatic acids (B) selected from the group consisting of phthalic acid, phthalic anhydride, isophthalic acid or terephthalic acid, and 40-60 mol % of two or more polyhydric alcohols (C) selected from the group consisting of triethylene glycol, dipropylene glycol, tripropylene glycol, Bisphenol A, trimethylol ethane, trimethylol propane, polyethylene glycol and derivatives thereof, polypropylene glycol derivatives thereof, polyethylene oxides, and trimethylol propane polymers wherein said polyhydric alcohols have an overall hydroxy functionality of 2 or 3 per molecule and a molecular weight of 600 to 1500 to make polymer/resin.

The said resins are dissolved in methanol, ethanol, acetone, Water or their mixtures in different proportions and Hardener and further admixed with filler and other additives to form a slurry;

The present invention is further illustrated by way of following non limiting examples.

### EXAMPLES 1

### Phenolic Resin

Phenol:Formaldehyde 1:0.9 mol ratio
Catalyst Sulfuric acid: 0.05 mol.

### Composite Manufacturing:

Resin: 80 parts,
Fiber: 20 parts
Jute or bamboo impregnated, coated or sprayed with resin
Moulded: pressure 0.1 ton per Sq. Inch.
Temperature: 90° C., time 5 min.

The properties of the product of present invention is compared with the jute composite product and the Bamboo Product. The jute composite product is formed by the method of IN179504. The Bamboo Products is as available. The comparison is tabulated below:

| Description | Jute | Bamboo | | Jute- |
|---|---|---|---|---|
| Composite | Composite | Longitudinal | Transverse | Bamboo |
| Cross Breaking (Mpa) | 70-80 | 55-60 | 4-5 | 100-120 |
| Tensile (Mpa) | 30-40 | 140-145 | 2-3 | 40-100 |
| Density (gm/cc) | 1.3-1.5 | 0.8(Dry) | — | 1.0-1.4 |
| Water Absorption (%) | 0.5-1.5 | 18-20 | 18-20 | 1.0-5.0 |
| Fire Retardant (in Sec.) | 05-30 | — | — | 05-30 |
| Compressive (Mpa) | 150-170 | 60-70 | 20-30 | 200-210 |

The above properties of invented Products i.e. sheet/board component made of composite product comprising Bamboo and Jute of any form or of any fibre or mixture is far superior to that sheet/board made from jute as described in the Indian Patent 179504 or from that of known bamboo product.

### EXAMPLE 2

### Phenolic Resin

Phenol:Formaldehyde 1:2.0 mol ratio

### Catalyst NaoH: 0.02 mol

Composite manufacturing:
Resin: 20 parts
Jute and bamboo fiber combination: 20 parts
Filler: Aluminum trihydrate: 60 parts
Moulded: pressure 20 ton per sq. inch
Temperature: 180 C, time 10 min.

### Size and Thickness of the Board

4′×8′ and 5′×10′

### Thickness

1.5 to 50 mm.
The boards have the following properties:

| SL. | PROPERTY | VALUE |
|---|---|---|
| 1. | Specific Gravity | 1.0 to 1.4 |
| 2. | Water Absorption (%) (Cold &Boiling) | 0.5 to 5.0 |
| 3. | Thermal Conductivity (‘K’ Value in MW/CM) | 0.3502 to 0.4250 |
| 4. | Tensile Strength (Mpa) | 60 to 100 |
| 5. | Cross Breaking Strength (Mpa) | 100 to 120 |
| 6. | Compressive Strength (Mpa) | 200 to 210 |
| 7. | Toxicity Index as per NCD 1409 | 1.47 (CO²0.53, CP-0.26, |
| | (BS 476 - Part 6 &7 - 1987) | HCHO - 0.55, NOX-0.13 |
| 8. | Limited Oxygen as per NCD 1410 | 28 |
| | (BS 476 - Part 6 &7 - 1987) | |
| 9. | Smoke Index as per NCD 1411 | 39 |
| | (BS 476 - Part 6 &7 - 1987) | |
| 10. | Electrical Test (As per IS: 1998/62) | |
| | a) Electrical Strength in oil edge-wise (Proof Test) KV | 8 to 30 |
| | b) Insulation Resistance in 18 hrs. water immersion | 21 to 26 |
| | by 500 Volts D.C in MEG-OHMS | |
| | c) Surface breakdown | 16 to 30 |
| | In Air after immersion in water (Proof Test) KV | |
| 11. | Corrosion Resistance | Free from Corrosion |
| 12. | Salt Spray (HRS.)(ECCA-T-8/ASTM-B-117-73) | No effect |
| 13. | Humidity (HRS.) (ECCA-T-10/ASTM-G-154) | No effect |
| 14. | Temperature Resistance | +200° C. |
| | | −30° C. |
| 15. | Special Tests | |
| | a) Acid Resistance | 5% HCL |
| | | 5% Sulphuric Acid |
| | | 10% Citric Acid |
| | | 10% Acetic Acid |
| | b) Alkali Resistance | 5% NaOH solution |
| | c) Solvent Resistance (Double Rubs) | MEX Xylene Ethyl Alcohol |
| | d) Grease Resistance | 50% Vegetable Oil |
| | | 50% Oelic Acid |
| | e) Stain Resistance (ASTM-D-1308) | Grease, Boot Polish |

### Experiment 3:

The method of forming the composite is as in experiment 1. However the proportion of bamboo and jute has been varied. In 3 a jute:bamboo: is 99:1, in 3b it is 1:1, in 3c it is 1:99 of reinforcement material. The properties of the composite product are given below:—

| | | Physical Properties | | | |
|---|---|---|---|---|---|
| Proportion | | | Cross | Water | Compressive |
| Jute | Bamboo | Tensile | Breaking | Absorption | Strength |
| 3a 99 | 1 | 60 | 85 | 1 | 180 |
| 3b 1 | 1 | 80 | 100 | 2 | 190 |
| 3c 1 | 99 | 100 | 120 | 5 | 210 |

### Observation:

1. When proportion of Jute & Bamboo is 99:1 the value of the Physical Properties said in above is lower.
2. When proportion of Jute & Bamboo is 1:99 the value of the Physical Properties said in above is highest.
3. At the middle point of the proportion i.e. 1:1 of the reinforcement material the value of the Physical Properties said in above is more or less medium.

### Conclusion:

The composite product of the present invention with the bamboo and jute in defined ratio provide the required properties like tensile strength, compressive Strength, Water Absorption, and the like properties are not possible from the material invented earlier from Natural Fibre and Natural Fibre Composite.

### BRIEF DESCRIPTION OF ACCOMPANYING DRAWINGS

FIG. 1: Flow diagram of process of manufacture of composite of present invention

FIG. 2: Graph illustrating the water absorption of composite with various proportions of bamboo to jute

FIG. 3: Graph illustrating tensile strength of composite with various proportions of bamboo to jute

FIG. 4: Graph illustrating compressive strength of composite with various proportions of bamboo to jute

### DETAILED DESCRIPTION OF THE ACCOMPANYING DRAWINGS

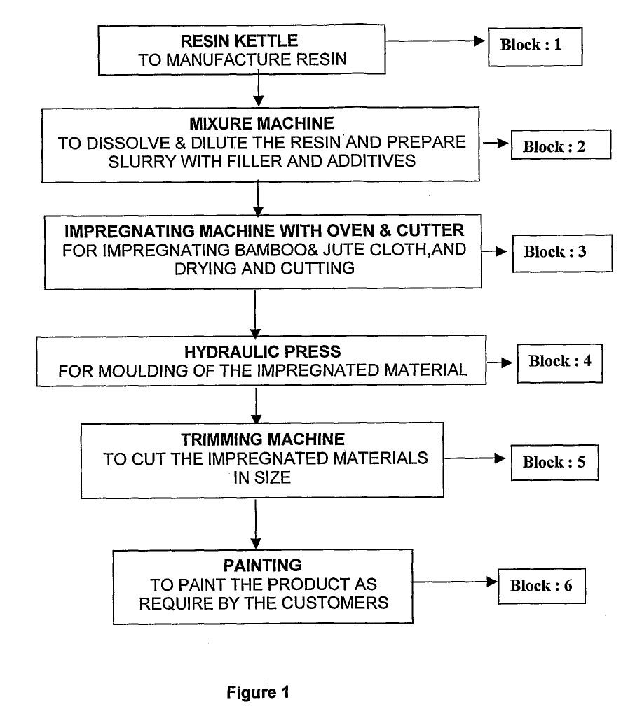

FIG. 1 illustrates the process for formation of the composite product of the present invention by way of a flow chart. The resin components are mixed and form the resin to be used in the present process. To it the additives and fillers are added to form the resin solution and the slurry is formed by addition of water methanol and hardener and mixed in a machine. Next the slurry is taken to the impregnating machine with oven and cutter for impregnation of bamboo and jute and followed by drying and cutting of the impregnated bamboo jute composite. Next it is passed to the hydraulic press for moulding of the impregnated material. This is the forwarded to the trimming machine for cutting the impregnating material according to desired size. Finally, the product thus form is painted as per requirement.

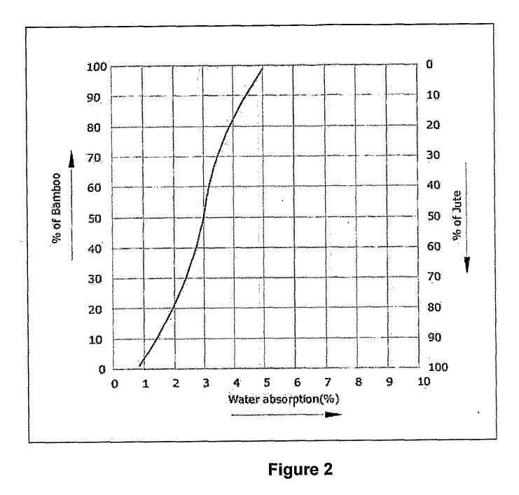

FIG. 2 illustrates the water absorption property of the bamboo jute composite of the present invention. The ratio of jute/bamboo is plotted against water absorption. It is found that with increase of ratio of jute:bamboo the water absorption property increases and at the ratio of 99:1 of the reinforcement material the water absorption property is the best.

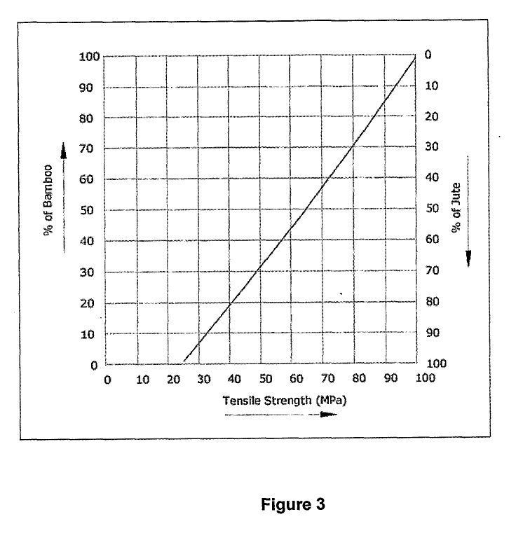

FIG. 3 illustrates the tensile strength of the bamboo jute composite with respect to the ratio of jute and bamboo in the composition. The ratio of jute:bamboo is plotted against the tensile strength and it is found that the best tensile strength is achieved when the jute/bamboo ratio is 1:99 of the reinforcement material.

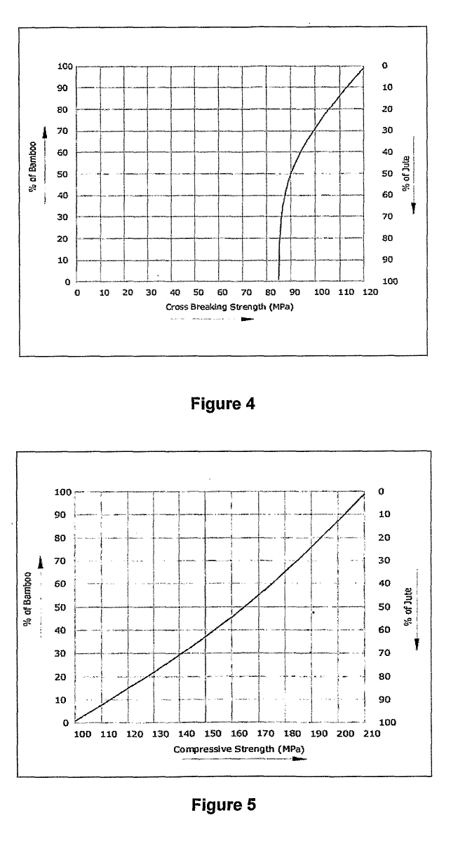

FIG. 4 illustrates the cross breaking strength of the bamboo jute composite with respect to the ratio of jute and bamboo in the composition. The ratio of jute:bamboo is plotted against the cross breaking strength and it is found that the best cross breaking strength is achieved when the jute/bamboo ratio is 1:99 of the reinforcement material.

FIG. 5 illustrates the compressive strength of the bamboo jute composite with respect to the ratio of jute and bamboo in the composition. The ratio of jute:bamboo is plotted against the compressive strength and it is found that the best compressive strength is achieved when the jute/bamboo ratio is 1:99.

Advantages the Product Obtained by this Process:—
Long lasting

### Low Thermal Conductivity

Electrical non-Conductive

### Fire Retardant

### Water Resistant

### Acid & Alkali Resistant

### Low Maintenance Cost

### Termite Resistant

### Anti-Abrasive

### Value for Money

Wide Range of uses

### Eco-Friendly

### Bio-Degradable

Ideal Substitute of Wood and Aluminium.

1. A natural fibre thermoset composite product of high tensile strength, high compressive strength, high cross breaking point, low water absorption properties comprising bamboo and jute fibre with or without other selective natural fibres, resins, fillers and additives, wherein bamboo and jute are present in the ratio of 1:99 to 99:1 of the reinforcement material and said natural fibres in amount of 1%-90% by wt. when present.

2. A composite product as claimed in claim 1 wherein said other natural fibres are selected from Bulrush (Hogla), Hem, Banana and pine apple, coconut fiber (coir), wheat flour, walnut shell flour, cashew nut shell flour, rice husk, sugar cane bagasee, wheat straw, rice straw, jute stick powder, wheat bran as filler/additive/reinforcement material.

3. The composite product as claimed in claim 1 wherein jute is present in amount of 10 to 80% by weight as reinforcement material selectively in the form of raw Jute, Jute Felt, Jute Cloth and the like.

4. The composite product as claimed in claim 1 wherein Bamboo is present in amount of 10 to 80% by weight as reinforcement material selectively in the form of strips, weaving mat, ordinary mat, powder, granules and the like.

5. A composite product as claimed in claim 1 wherein the resin is present in amount of 5 to 90% weight of the resin and selected from Phenol Formaldehyde, Urea Formaldehyde, melamine Formaldehyde, Phenol Melamine Formaldehyde, Phenol Urea Formaldehyde and Urea Melamine Formaldehyde, unsaturated polyester resin and their mixtures there of.

6. A composite product as claimed in claim 1 wherein filler is present in an amount of 10 to 90% and is selected from Aluminium Tri-Hydrate, Calcium Carbonate, Coconut Shell Powder, Marble Dust, Mica, Talc, Zinc Stearate, Rubber, chlorinated paraffin wax and Fly Ash, carbon blacks, fumed silica, precipitated silica, Alumina, ZnO, TiO2, Calcium Stearate, nanoclays like monmorillonite, bentonite, china clay, borates, phosphate, sulfate salts, Calcium Oxide, Magnesium Oxide, Slate dust, graphite, dolamite, wallastonite, Gypsum, Barytes, wheat flour, walnut shell flour, rice husk, sugar cane bagasee, wheat straw, rice straw, jute stick powder, cashew nut shell flour, Wheat bran, tributyl, Tin Oxide, sodium pentachlorophenate, borax, sodium fluoride, ammonium hydrogen phosphate and ammonium poly phosphate.

7. A composite product as claimed in claim 1 wherein said additive is in amount of 0.1 to 30% and selected from Ammonium Phosphate, Zinc Borate, Antimony Tri-Oxide and Borax, tributyl tin oxide, sodium pentachlorophenate, sodium fluoride.

8. A method of manufacture of natural fibre thermoset composite product of high tensile strength, high compressive strength, high cross breaking point, low water absorption properties comprising:
i. forming slurry with resin solution, fillers and optional additives;
ii. impregnation, spraying, coating of bamboo and jute provided separately or combined in a ratio of 1:99 to 99:1 mixture of resin, additives and filler into the slurry with or without other natural fibres selected from Bulrush (Hogla), Hem, Banana and pine apple, in amount of 1%-90% by wt. of reinforcement material when present;
iii. drying said impregnated/sprayed/coated reinforcement material (as in ii) in oven at temperature of 50° C. to 200° C.;
iv. cutting said impregnated/sprayed/coated and dried fibres or panels-into required size;
v. said impregnated/sprayed/coated dried cut pieces of bamboo and jute with or without said other natural fibres multilayered according to require thickness and pressed in the hydraulic press at a pressure 0.1 to 20 tons per square inches for a definite period at a defined temperature.

9. A method as claimed in claim 8 wherein jute is provided in amount of 10 to 80% by weight of reinforcement material selectively in the form of raw jute, jute felt, jute cloth and the like.

10. A method as claimed claim 8 wherein Bamboo is present in amount of 10 to 80% by weight selectively in the form of strips, weaving mat, ordinary mat, powder, granules and the like.

11. A method as claimed in claim 8 wherein the resin is selected from Phenol Formaldehyde, Urea Formaldehyde, melamine Formaldehyde, Phenol Melamine Formaldehyde, Phenol Urea Formal-dehyde and Melamine Urea Formaldehyde and their mixtures; filler is selected from Aluminium Tri-Hydrate, Calcium Carbonate, Coconut Shell Powder, Marble Dust, Mica, Talc, Zinc Stearate, Rubber, Chlorinated Paraffin Wax and Fly Ash, carbon blacks, fumed silica, precipitated silica, Alumina, ZnO, TiO2, Calcium Stearate, nanoclays like monmorillonite, bentonite, china clay, borates, phosphate, sulfate salts, Calcium Oxide, Magnesium Oxide, Slate dust, graphite, dolamite, wallastonite, Gypsum, Barytes, wheat flour, walnut shell flour, rice husk, sugar cane bagasee, wheat straw, rice straw, jute stick powder, cashew nut shell flour, Wheat bran, additive is selected from Ammonium Phosphate, Zinc Borate Antimony Tri-Oxide, and Borax, sodium fluoride, ammonium hydrogen phosphate and ammonium poly phosphate.

12. A method as claimed in claim 8 wherein the resin is present in amount of 5-90%, filler 5-60% and additive 0.1-30% of the slurry.

13. A Method as claimed in claim 8 where in the resin solution is prepared by reacting phenol with formaldehyde in the molar ratio (1.0:0.6 to 2.5) in condition selected from acid and alkaline condition.

14. A method as claimed in claim 13 wherein substituted phenols employed in the formation of the Phenolic resins are selected from alkyl substituted phenols, aryl substituted phenols, aralkyl substituted phenols, cycloalkyl substituted phenols, alkenyl-substituted phenols, alkoxy substituted phenols, aryloxy substituted phenols, and halogen-substituted phenols, the said substituents containing from 1 to 26, preferably from 1 to 9 carbon atoms.

15. A method as claimed in claim 14 wherein the phenols for preparing the resole resin composition are selected from hydroxybenzene (phenol), o-cresol, m-cresol, p-cresol, 3.5-xylenol, 3.4 xylenol, 3.4.5-trimethylphenol, 3-ethyl phenol, 3.5-diethyl phenol, p-butyl phenol, 3.5-dibutyl phenol, p-amyl phenol, p-cyclohexyl phenol, p-octyl phenol, 3.5 dicyclohexyl phenol p-phenyl phenol, pcrotyl phenol, phenylethyl, 3.5 dimethoxy phenol, 3.4.5-trimethoxy phenol, p-ethoxy phenol, p-butoxy phenol, 3-methyl-4-methoxy phenol, p-phenoxy phenol and mixture thereof.

16. A method as claimed in claim 8 wherein formaldehyde is used in combination with any of the aldehydes selected from acetaldehyde, propionaldehyde, butylaldehyde furfuraldehyde and benzaldehyde.

17. A method as claimed in claim 8 wherein aldehydes employed have the formula R¹ CHO wherein R′ is a hydrogen or hydrocarbon radical generally of 1-8 carbon atoms.

18. A method as claimed in claim 8 wherein the resin solution is prepared by reacting Melamine with formaldehyde in the molar ratio (1.0:30) in presence of alkaline catalyst.

19. A method as claimed in claim 8 wherein the resin solution is prepared by reacting Mixture of Phenol Urea Formaldehyde, Phenol Melamine Formaldehyde or Urea Melamine Formaldehyde in required proportion.

20. A method as claimed in claim 8 wherein the pressure of 0.1 to 20 tons per square inches is applied for a period of 5 to 60 Minutes at a temperature of 70° C. to 200° C. to form multilayered product.

21. A natural fibre thermoset composite product of high tensile strength, high compressive strength, high cross breaking point, low water absorption properties as substantially described herein with reference to the examples.

22. A Method of manufacturing Natural Fibre Thermoset Composite Product as substantially described herein with the reference to the examples and accompanying drawing.
